(19) United States
(12) Patent Application Publication
(10) Pub. No.: US 2007/0194920 A1
(43) Pub. Date: Aug. 23, 2007

(54) Focused alarm rationalization method

(75) Inventor: Bill R. Hollifield, Peel, AZ (US)

Correspondence Address: DUANE MORRIS LLP, 3200 SOUTHWEST FREEWAY, SUITE 3150, HOUSTON, TX, 77027, US

(73) Assignee: PAS, Inc.

(21) Appl. No.: 11/443,989

(22) Filed: May 31, 2006

Related U.S. Application Data
(60) Provisional application No. 60/775,116, filed on Feb. 21, 2006.

(51) Int. Cl. G08B 13/14

(52) U.S. Cl. 340/572.1; 340/506

(57) ABSTRACT

This invention is directed to a method for determining an alarm configuration in industrial alarm systems. In particular, the invention relates to a method of improving an existing alarm system through a process known as “Alarm Rationalization.” The conventional method of alarm rationalization is expensive and time-consuming. The present invention is directed to a novel Focused Alarm Rationalization method that is significantly less expensive and time-consuming than prior art Alarm Rationalization methods, but which yields equivalent performance results.

### CROSS REFERENCE TO RELATED APPLICATION

This application claims priority from provisional application Ser. No. 60/775,116, filed Feb. 21, 2006.

### BACKGROUND OF INVENTION

1. Field Of The Invention

This invention is directed to a method for determining an alarm configuration in industrial alarm systems. In particular, the invention relates to a method of improving an existing alarm system through a process known as “Alarm Rationalization.” The conventional method of alarm rationalization is expensive and time-consuming. The present invention is directed to a novel Focused Alarm Rationalization method that is significantly less expensive and time-consuming than prior art Alarm Rationalization methods, but which yields equivalent performance results.

2. Description of the Prior Art

A Distributed Control System (DCS) is a process control system that uses a network to interconnect sensors, controllers, operator terminals and actuators. A DCS typically contains computers for control rather than individual control hardware.

Process sensors, switches, controllers, actuators, and other inputs and outputs connected to the DCS typically monitor and affect the magnitude and/or change in process variables, such as temperature, pressure, flow, level, volume, voltage, amperage, resistance, composition, pH, and similar physical or calculated characteristics. The term “tag” is used to refer to an element configured in the control system, and tags are identified uniquely in the DCS. A tag can be an individual reading from the process (such as a pressure value, a temperature value, a flow value, the position of a switch or other type of on-off element, and so forth), a logically derived element (such as presenting a reading from one sensor under some logically-derived conditions, and a reading from a different sensor under other conditions), a calculated result involving readings from one or more sensors, calculations involving information from systems totally external to the DCS (such as current pricing of a component of the process) or other similar and flexible constructs. A tag can be created as a combination of other tags. The tags in a DCS can range from very simple, to quite complex and flexible in their configuration.

In a DCS, alarms can be optionally assigned, via simple software settings, to most types of tags. These are known as “alarmable tags.” An example is a tag representing a temperature reading having a “High Value” alarm set at a particular number. A single tag can have multiple alarms of different types. A tag representing a single temperature reading might have, for example, not only a “High” value alarm but also a “High-High” value alarm, a “Low Value” alarm, a “Low-Low” alarm, a rate-of-change alarm, an alarm indicating the signal has moved outside of a known range, and several other types. Different types of tags can have many different types of alarms. Different alarms may be assigned different “alarm priority” as well, wherein the priority attribute is used to distinguish alarms in a way that is helpful to the DCS operator, such as by their relative importance. Alarm Priority in a DCS is ranked from the “highest” priority level through 2, 3, or more “lower” priority levels. A single process may have thousands of tags, and thus even more thousands of configured alarms.

Prior to the introduction of the DCS, industrial process controls were collections of individual sensors, actuators, controllers, and the like without much of the flexibility, communication, and alarm assignment characteristics of a DCS. In the pre-DCS era, the control room of a processing facility would typically have a section reserved for hard-wired alarms. Such alarms were generally wall-mounted boxes containing light bulbs arranged in a rectangular array, where individual bulbs would illuminate an engraved description of the alarm it represented. These alarm displays were expensive to design, install, and maintain, so the decision to “create an alarm” was made with care and deliberation. The advent of the DCS enabled the creation of alarms via simple software settings and constructs, without additional hardware or cost, which were then shown on a CRT-type display. The result was that most DCS systems have been implemented with very large numbers of configured alarms, and in times of process upset or even under normal circumstances, generate more alarm events than can be effectively handled by the operator. The alarm system then becomes a hindrance rather than an aid. The problem of overloaded alarm systems is well-known and has been cited in investigation reports of major process accidents. The solution of the problem involves many elements.

One common element for dealing with this situation is an alarm system review concentrating on the proper selection and configuration of alarms. This alarm review is known to those skilled in the DCS art by many names, and will be herein referred to as “Alarm Rationalization.” This is a structured methodology involving group discussion (usually of engineers and process operators) of the process sensors or software construct comprised by the DCS.

The basic concept and methodology for Alarm Rationalization is covered in published articles and guidelines, such as the Engineering Equipment and Material Users Association (EEMUA) Publication 191, titled “Alarm Systems—A Guide to Design, Management, and Procurement.”

Alarm Rationalization generally encompasses many elements including, but not limited to (a) the appropriateness of any alarms currently configured for that tag, (b) whether any alarms on that tag are duplicated by other alarms on other tags, (c) causes of the alarm, (d) verification of the alarm signal, (e) consequences if the alarm receives no response, (f) corrective actions to be taken, (g) time available to take corrective action, (h) process history of the sensed variable, and (i) the proper priority to be assigned to each of the alarms.

Prior art alarm systems have been modified to match what is called for in the rationalization; this is known as “implementing the rationalization.” The resulting alarm configuration is said to be “rationalized.” Many prior art systems that have not been through rationalization have 90% or more of the alarmable tags configured with alarms. A typical control system may comprise thousands of alarmable tags.

Prior art published works on Alarm Rationalization, such as the before-mentioned EEMUA Publication 191, refer to performing it on all tags with existing configured alarms, or on all tags where it is possible to configure alarms. This method is thorough, but very costly.

Alarm Rationalization is a group effort, usually involving three to six people if done according to best practices. Since a typical DCS may involve thousands of tags, the effort can be very time-consuming and costly. For a typical 4,000 tag system, it is quite normal to spend more than $100,000 in man-hour costs alone in performing the review. Since the people performing the review must be knowledgeable of the process under discussion, this effort takes away from their current job duties, incorporating a significant work disruption as well.

This high cost and the tedious nature of the work are large disincentives for this important safety review. But, because of the safety implications of the effort, any attempts to make it more efficient should be rigorously and cautiously evaluated.

Conventional Alarm Rationalization looks at every tag on a system that is capable of being configured with an alarm. However, historical system analysis has shown that even over long periods of time (6 months to a year or more), the facts are that approximately one quarter of the alarmable tags produce all of the alarms during the periods analyzed, and less than one fifth produce more than 10 individual alarm events during the various analysis periods (ranging over many months/years).

It is believed that the majority of the time spent in a conventional alarm rationalization discussion is inefficient, discussing tags that have not produced an alarm or otherwise contributed to the alarm problem of the system. Thus a properly safeguarded methodology of selecting, for purposes of alarm rationalization, only tags whose alarms are contributing to the alarm problem on the system would thereby bring about substantial time and cost savings in the rationalization process, and accomplish the needed performance improvement as well. This methodology is a fundamental part of the invention of Focused Alarm Rationalization.

### SUMMARY OF THE INVENTION

The Focused Alarm Rationalization methodology described herein provides a high quality rationalization that is a significant cost and productivity improvement over the conventional method. Various embodiments of this Focused Alarm Rationalization methodology provide one or more of (a) alarm rationalization with significantly less effort than prior art methods and therefore reduce cost, and (b) no sacrifice in performance improvement of the post-rationalized alarm system compared to the conventional methodology.

Advances in computer technology and alarm analysis software have provided the ability to analyze many gigabytes of real-world alarm data, and to determine the actual functioning characteristics of many industrial alarm systems. Such advances are useful in practicing the present invention.

Focused Alarm Rationalization involves limiting the rationalization effort only to tags with alarms that are part of the alarm problem on the system. This involves specific prior analysis of the system to determine the list. Additionally, provisions are made to insure that the highest-priority alarms are properly addressed.

### DESCRIPTIONS OF THE DRAWINGS

FIG. 1a is a block diagram of first and third preferred embodiments of the Focused Alarm Rationalization Process.

FIG. 1b is a block diagram of second and fourth preferred embodiments of the Focused Alarm Rationalization Process.

FIG. 2a is a block diagram of a fifth preferred embodiment the Focused Alarm Rationalization Process.

FIG. 2b is a block diagram of a sixth preferred embodiment the Focused Alarm Rationalization Process.

### DETAILED DESCRIPTION OF THE INVENTION

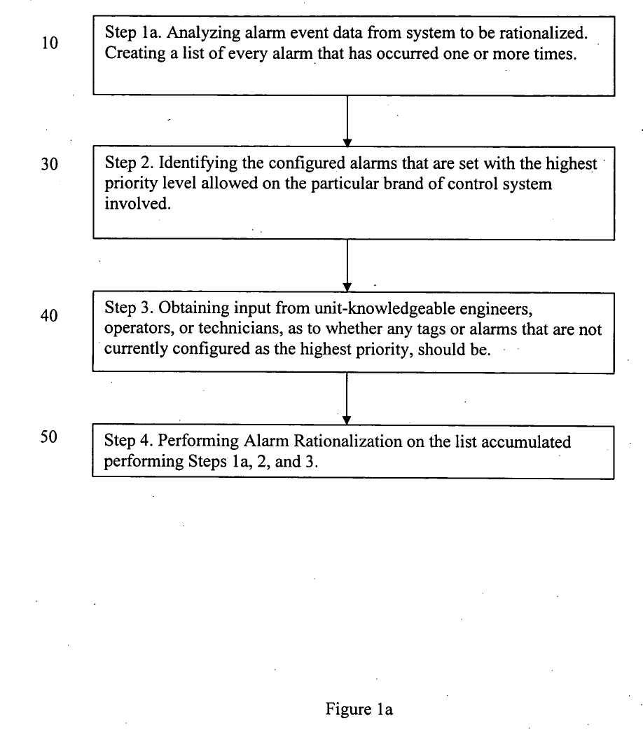

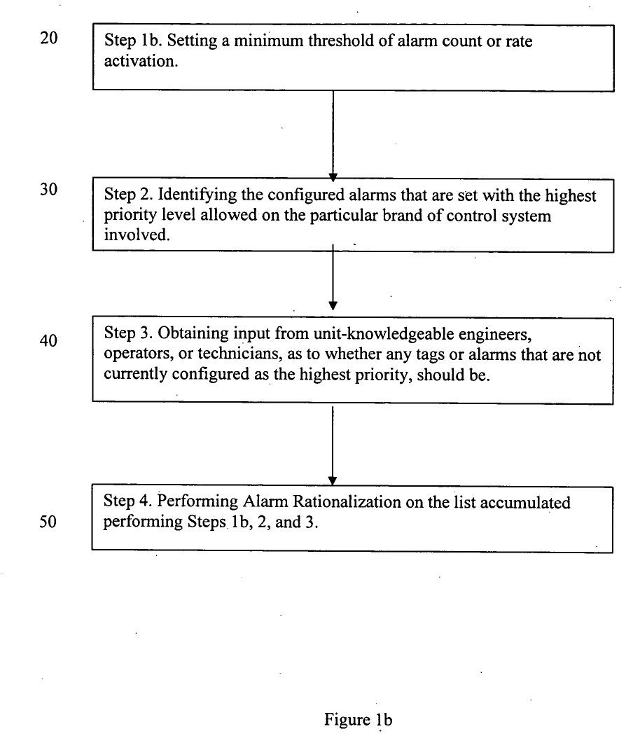

In one preferred embodiment, the invention is directed to a Three Step Focused Alarm Rationalization Methodology. The first step, Step 1a, is analyzing actual alarm event data from the system to be rationalized, as shown in block 10 of FIG. 1a. In a preferred embodiment, this analyzing is performed on data covering a time range of several months to a year or more. At least 6 months of data is a reasonable preferred minimum. Using a year's data has the advantage that any seasonal effects that influence the production of alarm events will be included. In a preferred embodiment, the analysis consists of counting and ranking all alarm events, separated by tag and alarm, from the most frequent to the least frequent during the time period. In a preferred embodiment, the results should be arranged to look similar to this:

| Tag | Alarm Type | Count of Alarm Events Produced |
|---|---|---|
| FC100 | HIGH Value | 14,312 |
| FC184 | LOW Value | 12,754 |
| TI1296 | Bad Value | 10,344 |
| PSH94 | OFF-NORMAL | 10,108 |

The above pattern is repeated, for the alarms in the system in decreasing count.

| | | |
|---|---|---|
| FI854 | HIGH Value | 2 |
| FI854 | LOW Value | 2 |
| FI854 | Bad Value | 1 |
| PI777 | HIGH Value | 1 |

There may be several hundred tags and alarms with very few events, or even only one event.

In a preferred embodiment, this list comprises the entire list of alarm events during the entire time period of the analysis. In a preferred embodiment, this is the beginning of the list to be subjected to Alarm Rationalization. This list will, based on historical analyses, typically be about 25-30% of the total alarmable tags on the system.

In another preferred embodiment the first step, Step 1b, is setting a minimum threshold of alarm count or rate activation, as shown in block 20 of FIG. 1b. For example, a threshold setting could be that any particular alarm must exceed a count of more than one alarm event per week or one alarm event per month before it is subject to rationalization. Alarms not meeting this threshold do not contribute significantly to an alarm system loading problem. Omit these alarms from the initial creation of the Focused Alarm Rationalization list. Historical analysis has shown that by setting even a small minimum threshold, hundreds of tags, based on a typical DCS tag count, can be omitted from rationalization without affecting the post-rationalization performance of the DCS. This may amount to an 80%-90% reduction in tag count compared to the standard methodology. That is, one can achieve the same system improvement with only one-tenth of the effort. This is another substantial incremental savings for Focused Alarm Rationalization, where this embodiment is chosen.

The second step, Step 2, comprises identifying the configured alarms that are set with the highest priority level allowed on the particular brand of control system involved, as shown in block 30 of FIGS. 1a and 1b. It is likely that many of these will not have produced even one alarm event during the time period analyzed in step 1, and would therefore not be on the list produced in Step 1a or 1b. Such configured tags and alarms are identified by comparison, and the list of alarms to be subjected to rationalization is modified to include all of these configured highest-priority alarms. This step will likely add less than five percentage points to the tag count used, based on historical analysis, as there are generally few alarms configured at the highest priority level in the DCS. In a preferred embodiment, the Tag list total for Focused Alarm Rationalization is now about 30-35% of the alarmable tags.

The third step, Step 3, comprises obtaining input from unit-knowledgeable engineers, operators, or technicians, as to whether any tags or alarms that are not currently configured as the highest priority, should be, as shown in block 40 of FIGS. 1a and 1b. In a preferred embodiment, this input includes references to any recent and relevant safety studies or process hazard studies of the system undergoing rationalization. Examples of such studies are the periodic Process Hazard Analyses as called for in OSHA 29 CFR 1910.119, Process Safety Management of Highly Hazardous Chemicals.

In a preferred embodiment, this embodiment further comprises identifying any alarms specifically called out for in such studies, that should exist on the system, that were not found in either Step 1a or 1b (from alarm events), or Step 2 (from the alarm configuration on the system). In a preferred embodiment, this embodiment further comprises adding the identified alarms to the list of tags to be subjected to rationalization. This step is useful because the actual alarm configuration found on the system in Step 2 may not accurately reflect what has been specified to be on the system. This step is an important safeguard, but will likely not add to the tag count for alarm rationalization in a significant amount.

Thus, a first preferred embodiment of the invention comprises Steps 1a, 2, and 3, while a second preferred embodiment of the invention comprises Steps 1b, 2, and 3, as shown in FIGS. 1a and 1b, respectively.

Two other preferred embodiments of the invention comprises the above Steps 1a or 1b, 2, and 3, as described above plus a fourth step, Step 4, which is performing Alarm Rationalization on the list accumulated performing Steps 1a or 1b, 2, and 3. These embodiments are shown in FIGS. 1a and 1b. Step 4 is shown in block 50 of FIGS. 1a and 1b. The time and cost will be directly related to the size of this list, which will be a substantial reduction from the conventional method of performing alarm rationalization on all alarmable tags.

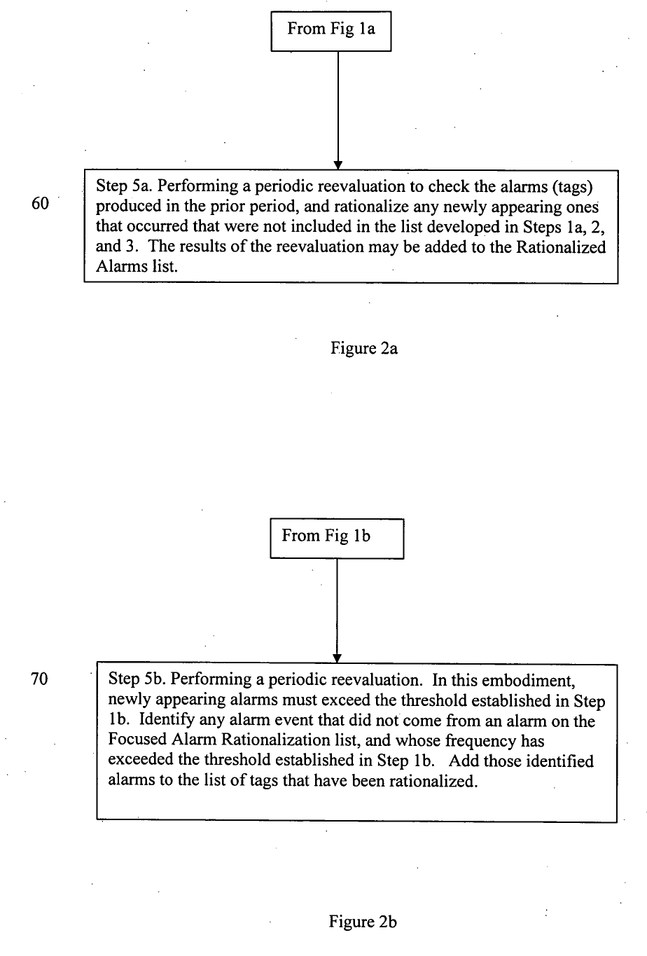

A fifth preferred embodiment of the invention comprises the above Steps 1a, 2, 3 and 4, as described above plus a fifth step, Step 5a, which is performing a periodic reevaluation to check the alarms (tags) produced in the prior period, and rationalize any newly appearing ones that occurred that were not included in the list developed in Steps 1a, 2, and 3. This embodiment is shown in FIG. 2a, wherein Step 5a is shown in block 60. In one preferred embodiment, this reevaluation is performed monthly. Alarm analysis software, such as PlantState Suite Alarm Analysis from PAS in Houston, Tex., makes identification of these tags a simple task. Other methods of examining the alarm records can be used to obtain the same results.

In a preferred embodiment, short rationalization meetings can be used to handle the small number of “new” tags involved, without disrupting work schedules of the personnel involved. The amount of tags that will be discovered in this monthly check will be related to the duration of the analysis used in Step 1; the longer that duration, the smaller this amount will be. As these additional tags and alarms are rationalized and implemented on the system, the list of Rationalized Alarms should be updated to include them for the next cycle of review in this periodic program.

A sixth embodiment of the invention comprises the above Steps 1b, 2, 3 and 4, as described above plus a fifth step, Step 5b, which is performing a periodic reevaluation, as shown in block 70 of FIG. 2b. This embodiment is shown in FIG. 2b. In this embodiment, newly appearing alarms must exceed the threshold established in Step 1b. Alarm analysis software, such as PlantState Suite Alarm Analysis from PAS in Houston, Tex., enables identification of these tags. Other methods of examining the alarm records can be used to obtain the same results.

In a preferred embodiment, short rationalization meetings can handle the relatively small number of “new” tags involved, without disrupting work schedules of the personnel involved. The amount of tags that will be discovered in this modified monthly check will also be related to the duration of the analysis used in Step 1b; the longer that duration, the smaller this amount will be. As these additional tags and alarms are rationalized and implemented on the system, the list of Rationalized Alarms should be updated to include them for the next cycle of review in this periodic program.

The foregoing disclosure and description of the inventions are illustrative and explanatory. Various changes in the illustrative method may be made without departing from the spirit of the invention.

What is claimed is:

1. A method for rationalizing alarm data from a distributed control system, comprising:
(a) analyzing alarm event data on a system comprising configured alarms to produce a list identifying the priority level of each alarm and the number of alarm events during the time period covered by the alarm event data;
(b) identifying the configured alarms that are set with the highest priority level allowed on the system and adding these identified alarms to the list produced in the analyzing step; and
(c) obtaining input from at least two persons knowledgeable to identify alarms not currently configured to the highest priority level which should be so configured from persons knowledgeable of a system, and adding such identified alarms to the list produced in the analyzing step.

2. The method of claim 1, wherein said analyzing is performed on data covering a time period of at least six months.

3. The method of claim 1, wherein said analyzing comprises:
(a) counting all alarm events; and
(b) ranking all alarm events from the most frequent to the least frequent during the time period over which alarm events have been counted.

4. The method of claim 1, further comprising performing alarm rationalization on the list of alarms produced in claim 1, wherein said rationalization comprises:
(a) evaluating the appropriateness of any alarms currently configured for each tag;
(b) evaluating whether any alarms on each tag are duplicated by other alarms on other tags;
(c) evaluating causes of the alarm;
(d) verifying the alarm signal;
(e) evaluating consequences of the alarm receiving no response,
(f) evaluating corrective actions to be taken;
(g) evaluating the time available to take corrective action;
(h) evaluating the process history of the sensed variable pertaining to each tag, and
(i) evaluating the priority to be assigned to each of the alarms.

5. The method of claim 4, further comprising performing a periodic reevaluation of the list obtained from claim 1 to add any newly appearing alarms.

6. The method of claim 5, wherein the periodic reevaluation is performed at least monthly.

7. The method of claim 1, wherein the persons knowledgeable comprise an engineer.

8. The method of claim 1, wherein the persons knowledgeable comprise an operator.

9. The method of claim 1, wherein the persons knowledgeable comprise a technician.

10. A method for rationalizing alarm data from a distributed control system, comprising:
(a) setting a minimum threshold of alarm counts;
(b) analyzing alarm event data on a system comprising configured alarms to produce a list identifying the priority level of each alarm and the number of alarm events for each alarm whose number of events over the time period evaluated exceeds the threshold;
(c) identifying the configured alarms that are set with the highest priority level allowed on the system and adding these identified alarms to the list produced in said analyzing step; and
(d) obtaining input from at least two persons knowledgeable to identify whether any alarms not currently configured to the highest priority level should be so configured from persons knowledgeable of a system and adding such identified alarms to the list produced from said analyzing step.

11. The method of claim 10, wherein said analyzing is performed on data covering a time period of at least six months.

12. The method of claim 10, wherein said analyzing comprises:
(a) counting all alarm events; and
(b) ranking all alarm events from the most frequent to the least frequent during the time period over which alarm events have been counted.

13. The method of claim 12, further comprising performing a periodic reevaluation of the list obtained from claim 10 to add any newly appearing alarms whose alarm frequency exceeds the threshold.

14. The method of claim 10, wherein the persons knowledgeable comprise an operator.

15. The method of claim 10, wherein the persons knowledgeable comprise a technician.

16. The method of claim 10, wherein the persons knowledgeable comprise an engineer.

17. A method for rationalizing alarm data from a distributed control system, comprising:
(a) analyzing alarm event data covering a time period of at least six months on a system comprising configured alarms to produce a list identifying the priority level of each alarm and the number of alarm events during the time period covered by the alarm event data, wherein said analyzing comprises counting all alarm events and ranking all alarm events from the most frequent to the least frequent during the time period over which alarm events have been counted;
(b) identifying the configured alarms that are set with the highest priority level allowed on the system and adding these identified alarms to the list produced in the analyzing step; and
(c) obtaining input to identify alarms not currently configured to the highest priority level which should be so configured from persons knowledgeable of a system, and adding such identified alarms to the list produced in the analyzing step.

18. The method of claim 17, wherein the persons knowledgeable comprise an operator.

19. The method of claim 17, wherein the persons knowledgeable comprise a technician.

20. The method of claim 17, wherein the persons knowledgeable comprise an engineer.
